(19) United States
(12) Patent Application Publication
(10) Pub. No.: US 2012/0314224 A1
(43) Pub. Date: Dec. 13, 2012

(54) METHOD AND IRRADIATING DEVICE FOR IRRADIATING CURVED SURFACES WITH NON-IONIZING RADIATION

(75) Inventor: Friedrich Luellau, Adendorf (DE)

(73) Assignee: LUELLAU ENGINEERING GMBH, Lueneburg (DE)

(21) Appl. No.: 13/581,055

(22) PCT Filed: Feb. 7, 2011
(86) PCT No.: PCT/EP11/00750

§ 371 Date: Aug. 24, 2012

(30) Foreign Application Priority Data
Feb. 26, 2010 (DE) 10 2010 009 554.0

(51) Int. Cl. G01B 11/24

(52) U.S. Cl. 356/601

(57) ABSTRACT

The invention relates to a method for irradiating a surface of a three-dimensional object, wherein a field of micromirrors in the beam path of a radiation source modulates the radiation. In order to be able to image irregularly shaped fields even on curved surfaces with the highest possible edge sharpness and to be able to exactly radiate the spatial distribution of the radiation power even onto three-dimensional surfaces, the topography (shape of the surface) is detected and a pulse duty factor is calculated and set for each micromirror so that the power density incident on a planar element corresponds approximately to a target power density and the target dimensions of the radiation surface. An irradiating device (1) for non-ionizing radiation for carrying out the method comprises a field having micromirrors, the field being controlled by a computer (2), and a so-called digital mirror device (DMD) (5), in the beam path (6) of a radiation source (7), wherein the device has at least one camera for detecting stripes or patterns projected onto the surface and a computer for calculating the surface.

The invention relates to a method for irradiation of a surface of a three-dimensional object, in which a field of micromirrors modulates the radiation in the beam path of a radiation source, and to an irradiation device for non-ionizing radiation, particularly in a wavelength range from 280 nm to 2500 nm, having a field of micromirrors controlled by a computer, a so-called Digital Mirror Device (DMD), in the beam path of a radiation source, preferably a lamp, an LED, or a laser, for irradiation of two-dimensional fields of any desired shape, on a surface to be irradiated.

Such a method and such irradiation devices are known, for example, from the patent application DE 10 2005 010723 A1 of the applicant, from which application the present application proceeds.

Further irradiation methods and irradiation devices for the medical sector are described, for example, in the documents US 2003/0045916 A1, U.S. Pat. No. 6,676,654, and U.S. Pat. No. 5,514,127.

Such irradiation devices can be used very advantageously in medical sectors, such as, for example, UV phototherapy or photodynamic therapy (PDT). But the irradiation device according to the invention can also find use in other industrial areas of application, such as, for example, in photochemistry, photobiology, or UV adhesive technology, if locally precise irradiation, which can be modulated in intensity, in the wavelength ranges from 280 nm to 2500 nm is concerned.

In contrast to technical solutions with gas lasers or solid body lasers, the radiation modulation using a DMD is very often advantageous, in terms of technology and price, if the applications do not necessarily require coherent, polarized, or extremely monochromatic radiation, if no energy density that is partially extremely great is required, such as for cutting or for material processing, for example, and if a planar or also a curved surface has to be irradiated.

In medical application sectors, in particular, non-ionizing irradiation device are under price pressure on the basis of the state-regulated billing rates, for example for phototherapy in the sector of dermatology. Even though the medical benefit in phototherapy resulting from new methods, namely being able to irradiate with precise contours and exact dosages, is of extreme importance, because it leads to a reduction in the cancer risk and to a clear reduction in the number of therapy applications required, this is not acknowledged by the health insurance organizations. For this reason, it is particularly important to find technically more cost-advantageous solutions. The device of the stated type allows irradiating surfaces that have irregular edges with precise adherence to these edges. Healthy skin parts are therefore not exposed to any radiation. Even within the surfaces, it can be practical to adjust the irradiation dose, which is the product of power density and duration, in locally individual manner. As a result, the irradiation can be adapted to a locally different, severe finding. Because the surfaces of three-dimensional bodies can be considered to be approximately planar only in small areas, the object must always be oriented toward the radiation source.

It is the task of the invention to avoid the disadvantages of the known devices and to make available a method as well as an irradiation device for non-ionizing radiation, in which the irregularly shaped fields, even on curved surfaces, can be imaged as precisely as possible, in terms of their edges, and the need for orienting the object relative to the radiation source can be avoided, to a great extent. Furthermore, it must be possible to precisely radiate the freely selectable local distribution of the radiation power, which is adapted to the findings profile, even onto three-dimensional surfaces. Finally, a cost-advantageous construction of the device is supposed to be usable for a broad application of therapy cases.

The task is accomplished, in the case of a method for irradiation of a surface of a three-dimensional object, in which a field of micromirrors modulates the radiation in the beam path of a radiation source, in that the three-dimensional shape of the surface is taken into consideration and its influence on the radiation dose that impacts a specific surface element is compensated, i.e. balanced out. For this purpose, the shape of the surface is first detected. This can take place by means of mechanical scanning of the surface, but preferably contact-free scanning. Known methods that can be mentioned are scanning by means of a laser, or point-by-point scanning with ultrasound, or three-dimensional evaluation of images from cameras that are space apart, or known strip projection methods, which are also referred to as strip image optometry. In this way, a cloud of points having the special coordinates of the measurement points is obtained, and stored in a memory of the computer as a data set. From this data set, the surface can be modeled digitally, and is therefore available for further calculations. The surface is divided up into surface area elements in the manner of a finite element model. The surface area, shape, position or orientation, and location are known for each of these elements. In this way, it is possible to determine or calculate the power density of the radiation that impacts the object for each surface area element, according to known mathematical rules, as a function of the orientation of the surface area element. The surface area elements are assigned to individual micromirrors, which serve for modulation of the power emitted by the radiation source. The aforementioned steps can also take place in a different sequence. For compensation of the curvature influence, a duty cycle is determined or calculated and adjusted for each micromirror, in such a manner that the power density that impacts a surface area element corresponds to a reference power density. The local reference power density is set on the monitor, for example. Corresponding to the finding of a diseased skin part, it is established in locally different manner. The dose radiated onto a surface area element results from the power density of the impacting radiation multiplied by the duration of the irradiation procedure. Control of the micromirrors and irradiation of the object takes place, for the duration of an irradiation procedure, at the duty cycle that was previously set. The result of the irradiation is therefore advantageously independent of the curvature and the incline, i.e. the orientation of the surface. The object therefore does not necessarily have to be oriented in advance, in complicated manner. The method task has therefore been accomplished.

The task is alternatively accomplished in that first the surface is irradiated with a radiation density independent of location. In this connection, the micromirrors of the DMD all have the same duty cycle, and the image of the reflected power density is recorded. The diffuse reflection in the direction of a camera recording the image is dependent on the orientation of the surface area relative to the optical axis. In this connection, it is advantageous if the camera is disposed in the beam path, so that parallax is avoided. The image is divided up into surface area elements, for example by means of a predetermined raster pattern. Micromirrors are individually assigned to the surface area elements in accordance with this raster pattern. As described above, a duty cycle is determined or calculated for each micromirror, and adjusted in such a manner that the power density that impacts a surface area element approximately corresponds to the reference radiation power density. Control of the micromirrors and irradiation of the object take place, for the duration of an irradiation procedure, at the previously set duty cycle. The reflection values detected by the camera can be stored in the computer as a data set that describes the local distribution of the radiation power of the radiation source. In this manner, the local distribution of the radiation power is detected by means of measurement technology, and is automatically balanced out over the entire surface area by means of a change in the individual duty cycles of the individual micromirrors, so that the same reference power impacts everywhere on an object to be irradiated.

In an embodiment of this method, the duty cycle of the micromirrors can advantageously be adapted automatically, in such a manner that the image of the local power density is approximately the same everywhere. This can take place in the form of a regulation circuit that individually and automatically adapts the duty cycle of each individual image point of the DMD, during irradiation, to the current image of the camera. Movements of the object can thereby be automatically corrected. Such a regulation circuit can also be implemented digitally, by means of an image recognition unit. For this purpose, the measurement values of the camera or another suitable sensor are passed, in a regulation circuit, to the controller of the micromirrors. This setting is then maintained for the entire irradiation procedure. The use and evaluation of a camera signal therefore allows regulation of the radiation power, even during the irradiation procedure, in real time. The duty cycle of the micromirrors is adapted automatically.

Determination of the shape can take place in particularly advantageous manner by means of a strip projection method, because for this purpose, the DMD can be used for generation of the strip pattern. The camera that has already been mentioned can also record the projected patterns and pass them on to the computer for evaluation. If a second camera is provided, surface areas that lie in the image shadow of the first camera can also be recorded and calculated.

The influence of voltage variations or an aging-dependent decrease in the radiation power of the radiation source can advantageously be compensated if the radiation power of the radiation source is measured and a drop in the radiation power is automatically balanced out. The measurement can take place by means of a sensor that is disposed in the immediate vicinity of the radiation source.

The measures described above compensate the influence of the shape of the object. System-related deviations in the optics should also be taken into consideration.

The influence of the optical system can be taken into consideration if weakening of the radiation power, locally caused by the optics, or imaging errors of the optics are measured and automatically balanced out. This distribution can advantageously be measured as a system constant.

For example, a planar gray-scale plate can be exposed, and the rastered camera image of this plate can be evaluated. For this purpose, planar gray-scale plates are irradiated, and duty cycles are determined and adjusted in such a manner that they can be stored in the memory of the computer as a data set that describes the local distribution of system-related errors. This data set contains the system-related influence variables.

Because the locally dependent distribution of the power density is stored in the memory of the controller as a data set, the values are then available for further calculation steps. For example, they are used for the determination of a locally dependent duty cycle of the micromirrors. The duty cycle represents the ratio of the times during which the micromirror is directed at the surface to be irradiated, relative to the period duration of a sweep frequency with which the micromirrors are controlled. At locations where the radiation power is initially lower, the time during which the micromirror is directed at the object is extended, while this time is shortened at locations where the radiation power is initially higher. Therefore the radiation power values come to be the same, to a great extent, over the entire surface area to be irradiated, independent of the location on the surface area, in each instance.

In another embodiment of the method, it is provided that the detection of the shape of the surface repeatedly takes place in real time, during the duration of the irradiation procedure. In this manner, movements of the object can be recognized, and the irradiation field can be tracked, in that, for example, micromirrors that were previously turned off are turned on again, others are turned off, and the duty cycles of the others are adapted.

The system parts that are already present, particularly the camera and the DMD, can advantageously be used also for focusing, in addition, if the distance between surface and imaging optics is adjusted, by a motor, when a start signal is given, in such a manner that the device demonstrates optimal focusing.

For example, the device can have an auxiliary light source, preferably a laser beam, which projects an image onto the surface. The computer generates a target image on the object, by means of suitable control of the DMD. An actuator adjusts the distance between the surface to be irradiated and the imaging optics. The precision of focusing on the surface can be visually checked by means of the two images. The position of the generated image relative to the target image generated by the DMD is a measure for the precision of the focusing. By means of changing the distance between the surface to be irradiated and the imaging optics, the images can be brought into congruence. In this way, the surface to be irradiated lies in the focal plane of the DMD. The distance can also be adjusted manually. In this way, a rapid and cost-advantageous reproducible adjustment possibility for such irradiation devices is created, in order to bring the surface to be irradiated into congruence with the focal plane.

When using zoom optics, the actuator can analogously also adjust the focal width of the zoom optics, if imaging optics having a variable focus are present.

If the device has an image recognition unit for evaluation of the target image recorded by the camera and/or of the image generated by the auxiliary light source, focusing can also be undertaken automatically in this way, by the image recognition unit. When a start signal is given, the distance between imaging optics and the surface to be irradiated is changed until the image of the auxiliary light source and the target image are congruent with one another and thus focusing has been completed.

In an embodiment in which the output of a light waveguide, at the input of which a lamp, an LED, or a laser is disposed, serves as the radiation source, the lamp can advantageously be operated separately from the irradiation head. The irradiation head is therefore lighter and can be adjusted more easily. Furthermore, the dissipation of waste heat of the lamp or the LED or of a plurality of LEDs is facilitated. Because of the higher radiation power that can be achieved, the treatment duration is advantageously reduced.

The influence variables that determine the radiation that impacts a surface area can be broken down into variables that relate to the system, in other words the device, and variables that relate to the object, in other words the shape of the object. In order to achieve a power density that corresponds to the reference power density, it is provided that a data set that describes the local distribution of the radiation power is stored in a memory of the computer as a first parameter, i.e. influence variable, and/or that a data set that describes the spectral distribution of the power is stored as a second parameter, and/or that a data set that describes the aging is stored as a third parameter, and/or that a data set that describes the local distribution of a weakening coefficient of the optical system, between the radiation source and the surface to be irradiated, is stored as a fourth parameter.

In summary, therefore, the parameters that influence the radiation power on the three-dimensional surface area is determined, in the irradiation device for non-ionizing radiation according to the invention, in that first, the topology of the three-dimensional surface is determined, a topology correction data set is generated from this, and second, the system-related parameters that influence the local radiation power are determined in a system correction data set, by means of measurement of the reflections on a planar surface area. As the result of linking of the local reference values with the topology correction data set and the system correction data set by the computer, the actual radiation power on the three-dimensional surface area corresponds to the desired local distribution of the radiation power, by means of corresponding control of the micromirrors.

In this connection, determination of the topology correction data set takes place using the strip projection method, in that the micromirrors which are already present, as part of the system, take over the required projections with light in the visible range, and the camera of the irradiation device, which is also present as part of the system, takes on the task of scans the strip projections for an evaluation by the computer. The same advantage, namely the use of the existing micromirrors for projection of a gray-scale image and the existing camera evaluation of the gray-scale image, is utilized in the calculation of the system correction data set. In this way, a particularly cost-advantageous construction of the device is achieved.

A preferred embodiment of the invention will be explained as an example, using the drawing. The figures of the drawing, show, in detail:

FIG. 1 a schematic side view of the irradiation device according to the invention,

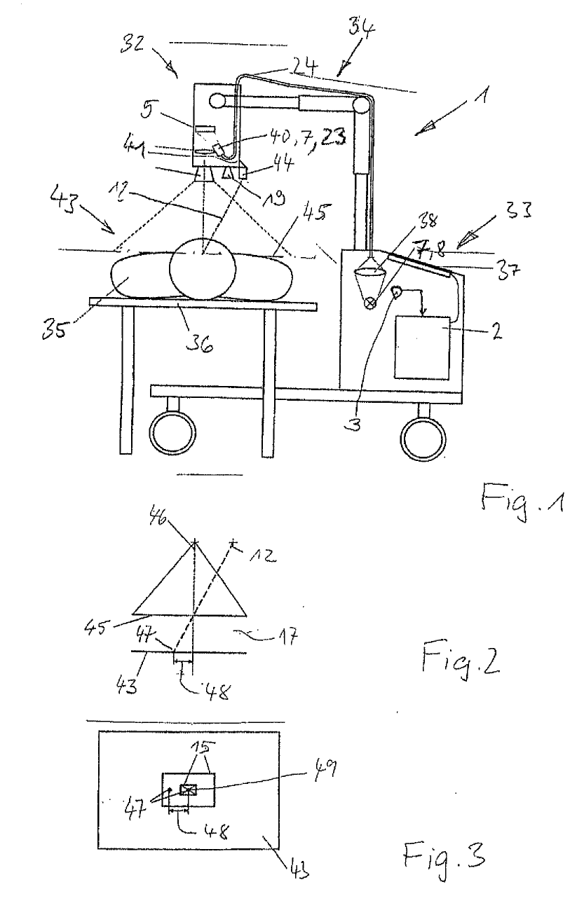

FIG. 2 a schematic partial view according to FIG. 1, for an explanation of the distance measurement,

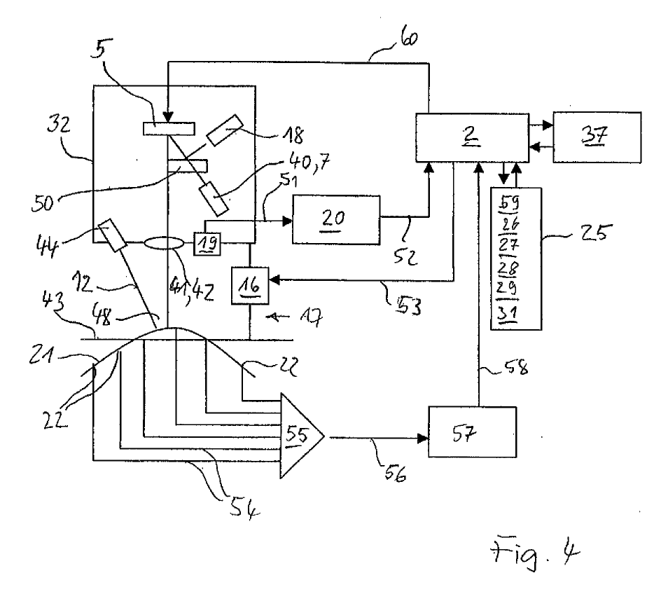

FIG. 3 a schematic top view of the irradiation surface area, for an explanation of the focusing, and

FIG. 4 a schematic representation of significant functional blocks of the device according to the invention.

The irradiation device 1 according to the invention shown in FIG. 1 is divided into an irradiation head 32, a controller housing 33, and a guide rod system 34 that connects these two modules. The irradiation head must be brought into position on this rod system 34, above a patient 35 who is lying on a treatment table 36.

A computer 2 that contains the controller software, having a display 37, is installed in the controller housing 33; the display shows not only the patient data but also the treatment parameters, the treatment history, the treatment area, and the image of a camera 19. Furthermore, the housing contains the radiation source 7, i.e. an arc lamp 8, for example, and collimation optics 38, which couple the radiation into a light waveguide bundle 24. The device parts that are necessary beyond these, such as fans, power supplies, etc., for operation of the aforementioned modules, have not been shown, for the sake of clarity of the illustration.

A filter 4 is additionally indicated in front of the lamp 8. This filter is pivoted into the beam path to bring light having a specific wavelength onto the surface area to be irradiated. For example, no UV light is required for projection of the target image. Then, only the visible spectral components are used.

The sensor 3 shown in the region of the lamp 8 detects the scattered radiation of the lamp 8. The output of the sensor makes a signal available to the computer, which images the current radiation power of the lamp. In the case of an aging-related decrease in power, the signal level of the sensor 3 also changes, so that the controller can adjust the supply voltage of the lamp 8 in order to compensate the power decrease.

The light coupled into the light waveguide 24 exits in the radiation head 32 and is directed to a field of micromirrors, the DMD 5, by the optics 40; there, the light is modulated, in order to then impact the surface area 43 to be irradiated, by way of the imaging optics 41 with lens 42. The end of the light waveguide 24 can therefore be considered to be a radiation source 7, and takes on the function of the radiation source.

For focusing of the imaging optics, a laser 44 is integrated into the irradiation head 32, in addition, eccentric to the optical axis of the imaging optics 41, which laser directs a beam 12 onto the surface area 43, for example, so that an image point 47 is formed there. The laser beam 12 is directed in such a manner that it intersects the optical axis 46 of the imaging optics 41 in the focal plane 45.

FIG. 2 shows the conditions during focusing. As long as the surface area 43 to be irradiated lies outside the focal plane 45, the image point 47 generated by the laser beam 12 lies at a distance 48 from the optical axis 46 on the surface area 48. The surface area 43 can be brought into congruence, at least in part, with the focusing plane 45, by means of changing the distance 17 between the irradiation head 32 and the irradiation surface area 43.

FIG. 3 shows a top view of an irradiation surface area 43 for an explanation of the focusing procedure. The outer edge of the irradiation surface area 43 shows the maximal expanse of the irradiation surface area 43. Within this, a target image 15 is projected onto the surface area. This can take place either using the radiation source 7 in combination with the DMD 5, using the imaging optics 41, or by means of separate optics. As long as the focal plane 45 is not congruent with the irradiation surface area 43, the image point 47 lies outside the target 49.

For this reason, in FIGS. 2 and 3, the distance 17 should be decreased until the image point 47 of the laser beam 12 has migrated into the target 49. Focal plane 45 and irradiation surface area 43 then lie in a plane, assuming a planar irradiation surface area whose surface normal line is directed parallel to the optical axis. This setting can be observed and checked on the patient with the naked eye, or also viewed on the display 37. A corresponding evaluation of the image of the camera 19 (FIG. 4) using the image recognition unit 20 (FIG. 4) and automation of the adjustment procedure are also possible. In this connection, the distance of the image point 47 from the target point 49 and its location, to the right or left of the image point, are evaluated and fed back, in a control or regulation circuit, to an actuator 16 that changes the distance 48 between focal plane 45 and irradiation surface area 43. The side position of the image point 47 indicates the sign of the setting variable.

FIG. 4 shows the significant functional groups as blocks in a schematic overview. In this figure, the regulation circuit described above, for focusing of the irradiation optics, can be seen. The camera 19 records the target image 15 and the image point 47, and passes the image signal on, by way of line 51, to the evaluation unit 20, which determines the distance 48 between image point and target point, as well as its side position. The evaluation unit 20 passes the actual value on to the regulator, here implemented digitally as computer 2, by way of line 48. This computer calculates the setting variable according to amount and sign, and passes it on, by way of line 53, to the actuator 16, which adjusts the distance 17. With this, the regulation circuit is closed.

The auxiliary light source 40 in the irradiation head 32 is provided for generation of the target image 15; this source directs visible light through a semi-permeable mirror 50 onto the DMD 5. The micromirrors of the DMD 5 are controlled by computer 2 in such a manner that the DMD modulates the light so that the target image 15 occurs on the irradiation surface area 43.

In reality, the irradiation surface area 43 is not planar, but rather more or less curved. As a result of the depth of focus of the optics, this is unproblematic. However, the incidence power and therefore the local radiation dose change, depending on the incidence angle. In order to balance this out, a two-dimensional field 21 of sensors 22 is shown in FIG. 4, which sensors measure the incident radiation locally. The sensors are embedded in a flexible mat and measure in the direction of the local surface normal line of this mat. If the mat is laid onto a curved irradiation surface area, it lies against the surface area, and the locally measured values of the sensors take the incidence angle onto the curved irradiation surface area into account. The signal of the sensors 22 is passed, for example, to a multiplexer, by way of lines 54; this multiplexer queries the sensors sequentially and passes the measurement signal on to an A/D converter 57, by way of line 56; this converter, in turn, reports the value to the computer by way of line 58. The values of all the sensors form a matrix, whose data set 59 is stored in memory 25. This data set 59 is then used for calculation of the duty cycle of each micromirror of the DMD 5, in order to compensate the local differences of the power radiated in. At locations where a lower radiation power was measured than the average radiation power, the ratio of the turn-on duration of a micromirror relative to the total duration of an on/off cycle of the micromirror is increased in such a manner that the radiation power corresponds to the average radiation power. At locations where a higher radiation power was measured, compensation takes place analogously; the duty cycle is therefore reduced analogously. Instead of the measured values, of course, the calculated correction values or both values can be stored in memory 25 and used for equalization.

The computer finally controls every micromirror by way of power 60, so that the same power impacts at every location on the surface area to be irradiated.

Alternatively or supplementally, the image of the camera 19 can also be evaluated, and the reflection values measured by the camera in the case of uncompensated radiation, i.e. when the duty cycles of all the micromirrors are the same, can be utilized to determine a corresponding value matrix that is suitable for local correction of the micromirrors.

For example, for compensation of differences of the power density, for example caused by the optical system, a planar plate having a firmly defined reflection layer can be laid into the focal plane. A gray-scale image having a defined, equal duty cycle of all the image points in the visible light spectrum is projected onto this. The camera 19 and the subsequent software raster the projected image into equal partial surface areas, and determine the brightness values for each partial surface area. The brightness values are standardized and stored in memory 25 as a value matrix, and used for correction of the local radiation density as described above.

To take differences in the power densities in the irradiation of curved surface areas into consideration and to compensate them, the existing DMD 5 and the camera 19 with computer 2 can advantageously be utilized also for measurement and determination of the topology of the surface area to be irradiated. The DMD is therefore given an additional task, namely modulation and projection of strip patterns onto the surface to be irradiated, so that the camera and the computer determine the topology of the surface area from this, according to known methods. From this, the local direction of the surface normal line of the irradiation surface areas is calculated, and the local duty cycles of each micromirror, as required for compensation of the existing differences and the different radiation powers that result from them, are calculated and stored in memory 25 as a value matrix.

The camera, which essentially has the task of recognizing the diseased skin surfaces of the patient and measuring the position of the patient, is therefore additionally used to evaluate the strip patterns during the strip projection method. AS a result, a particularly cost-advantageous solution has been found.

Other parameters can also be taken into consideration for compensation, and their value matrix can be stored in memory 25. For example, a data set 27 can be stored in memory 25, as a value matrix that images the local distribution of the spectral composition and/or distribution of the light, and/or a data set 28 that images the aging function of the radiation source locally and/or spectrally, and/or a data set 29 that images the weakening caused by the optical components that lie in the beam path. These data sets can have the data sets 29 of the sensors and/or of the topology that were described above superimposed on them, and can be linked to produce a correction data set that takes all the parameters into consideration.

The invention can advantageously find use not only in the medical sector, such as UV phototherapy or photodynamic therapy, as a device and a method for irradiation with non-ionizing radiation, but also in photochemistry, photobiology, or UV adhesive technology. It allows shortening the therapy or irradiation period as a whole, in advantageous manner, and precisely delimiting the irradiated surface areas, as well as effectively tracking the object to be irradiated in the event of movement. The risk of radiation damage is reduced.

### REFERENCE SYMBOL LIST

1 irradiation device
2 computer
3 sensor
4 filter
5 DMD
6
7 radiation source
8 arc lamp
9
10
11
12 laser beam
13
14
15 target image
16 actuator
17 distance
18 light source
19 camera
20 image recognition unit
21 field
22 sensor
23
24 light source conductor
25 memory
26 data set
27 data set
28 data set
29 data set
30
31 data set
32 irradiation head
33 controller housing
34 guide rod system
35 patient
36 table
37 display
38 collimation optics
39
40 optics
41 imaging optics
42 lens
43 surface area
44 laser, auxiliary light source
45 focal plane
46 optical axis
47 image.
48 distance
49 target
50 semi-permeable mirror
51 line
52 line
53 line
54 line
55 multiplexer
56 line
57 analog-digital converter
58 line
59 measurement data set
60 line

1. Method for irradiation of a surface of a three-dimensional object, in which a field of micromirrors modulates the radiation in the beam path of a radiation source, wherein
the topography (shape of the surface) is recorded,
the surface is divided up into surface area elements,
the power density of the radiation that impacts the object is determined or calculated for every surface area element, as a function of the position of the surface area element,
the surface area elements are assigned to individual micromirrors,
a duty cycle is determined or calculated and adjusted for every micromirror, in such a manner that the power density that impacts a surface area element approximately corresponds to a reference power density and the reference dimensions of the radiation surface area,
control of the micromirrors and irradiation of the object for the duration of an irradiation procedure, at the previously set duty cycle.

2. Method for irradiation of a surface of a three-dimensional object, in which a field of micromirrors modulates the radiation in the beam path of a radiation source, wherein
the surface is irradiated with a location-independent power density,
the image of the reflected power density is recorded,
the image is divided up into surface area elements,
the surface area elements are assigned to individual micromirrors,
a duty cycle is determined or calculated and adjusted for every micromirror, in such a manner that the power density that impacts a surface area element approximately correspond to a reference power density and the reference dimensions of the radiation surface area,
control of the micromirrors and irradiation of the object for the duration of an irradiation procedure, at the previously set duty cycle.

3. Method for operation of an irradiation device according to claim 2, wherein the duty cycle of the micromirrors is automatically adapted in such a manner that the image of the local power density is approximately the same everywhere.

4. Method for irradiation of a surface according to claim 1, wherein the determination of the topography (surface shape) takes place by means of a strip projection method.

5. Method for irradiation of a surface according to claim 1, wherein the radiation power of the radiation source is measured, and a drop in the radiation power is automatically balanced out.

6. Method for irradiation of a surface according to claim 1, wherein a weakening of the radiation power caused by the optics, in locally dependent manner, is measured and automatically balanced out.

7. Method for irradiation of a surface according to claim 1, wherein the locally dependent distribution of the power density is stored in the controller as a data set.

8. Method for irradiation of a surface according to claim 1, wherein the detection of the topography and/or relative position of the surface takes place repeatedly in real time, during the duration of the irradiation procedure.

9. Method for irradiation of a surface according to claim 1, wherein when a start signal is given, the distance between surface and imaging optics is motor-driven automatically changed, until the device demonstrates optimal focusing.

10. Irradiation device (1) for non-ionizing radiation, particularly in the wavelength range from 280 nm to 2500 nm, having a field of micromirrors controlled by a computer (2), a so-called Digital Mirror Device (DMD) (5), in the beam path (6) of a radiation source (7), preferably a lamp (8), an LED, or a laser, for irradiation of fields of any desired shape, on a surface (43) to be irradiated, wherein the device has at least one camera for recording of strips or patterns projected onto the surface and a computer for calculation of the surface.

11. Irradiation device (1) according to claim 10, wherein the computer (2) for control of the DMD (5) is configured for generation of a target image (15, 49), as well as that an actuator (16) is provided for adjustment of the distance (17) between the surface (43) and imaging optics, for automatic focusing of the target image on the surface of the irradiation object to be irradiated.

12. Irradiation device according to claim 1, wherein the output (23) of a light waveguide (24), at the input of which a lamp (8) or an LED or a laser is disposed, serves as the radiation source (7).
